(19) United States
(12) Patent Application Publication
(10) Pub. No.: US 2009/0093137 A1
(43) Pub. Date: Apr. 9, 2009

(54) OPTICAL COMMUNICATIONS MODULE

(75) Inventors: Avner Badehi, Harei Yehuda (IL); Sylvie Rockman, Zichron Ya'akov (IL); Oded Globerman, Tel-Aviv-Yafo (IL); Dubravko Babic, Tel-Aviv-Yafo (IL)

Correspondence Address: PERKINS COIE LLP, P.O. BOX 1208, SEATTLE, WA, 98111-1208, US

(73) Assignee: XLoom Communications, (Israel) Ltd., Tel Aviv-Yafo (IL)

(21) Appl. No.: 12/208,310

(22) Filed: Sep. 10, 2008

Related U.S. Application Data
(60) Provisional application No. 60/998,273, filed on Oct. 8, 2007.

(51) Int. Cl. H01R 12/00

(52) U.S. Cl. 439/61; 439/55

(57) ABSTRACT

A communications adaptor card is disclosed herein. One embodiment of the communications adaptor card comprises, a printed-circuit board, the printed circuit board having at least one keep-out area, the at least one keep-out area configured to accept a multi-contact electrical connector receptacle and at least one optical module attached to the printed circuit board. The at least one optical module can be attached to the printed circuit board substantially within the at-least-one keep-out area.

### CROSS REFERENCE TO RELATED APPLICATION

This application claims priority to U.S. Provisional Patent Application Ser. No. 60/998,273 filed Oct. 8, 2007, entitled “Optical communications adapter card”, which is hereby incorporated by reference.

### TECHNICAL FIELD

The present invention relates to an optical transceiver, and in particular to an optical transceiver for use in short reach links that is used in place of standard copper link connectors.

### BACKGROUND

Interconnects operating multi-gigabit per second line rates have become ubiquitous in the enterprise, storage, and server markets. Yet, the demand for higher bandwidth is expected to grow further over the next few years. Server connectivity with aggregate bandwidths of 40 Gb/s per interconnect are already being designed by multiple system developers. The critical parameters system designers deal with when deciding on what type of interconnect to use are cost, reach, and bandwidth. The price a system developer is willing to pay for a communication link depends on the number of links needed and how that cost distributes over an entire system. Central offices, data centers, storage facilities, and server farms require large bandwidth over short distances and constitute the highest concentration of interconnects. They hence represent the most cost-sensitive point in a network system. Short-distance links extent over less than about 300 meters and connect equipment in different building, rooms and racks of equipment.

There are fundamentally two technologies used to realize abovementioned short-distance interconnects: electrical and optical cabling. The choice of technology is governed by performance and price. The performance is determined by the acceptable signal distortion which is function of the signaling rate and the reach, while the price depends on the technology used. Electrical wires are generally, but not always, less expensive than optics for reaches and rates at which either technology can be used. Electrical signals get distorted when they propagate though through electrical wires and this distortion is larger the higher the line rate and the longer the distance of propagation. This type of limitation applies for any communication system: the product of the bandwidth and the distance of propagation is approximately constant for any one communication technology. Optical signals propagating over optical fibers are similarly limited, but the reach is significantly larger with optical fibers than electrical wires for a given line rate. For this reason, electrical signals are used for short distances (tens of meters) and optics for long distances (beyond tens of meters).

In order to increase the aggregate bandwidth of an electrical interconnect, multiple wires are run in parallel while the signaling rate per wire is kept low to limit the distortion. Similar approaches are being used in optics and this technology is commonly known as multi-channel or parallel optics. Data center connectivity requires large amount of bandwidth over distances ranging from several meters to several hundreds of meters.

### BRIEF DESCRIPTION OF THE FIGURES

FIG. 1 Dual-Port Infiniband™ Host-Channel Adapter (HCA) card 100.

FIG. 2 One implementation of the CX4 connector receptacle.

FIG. 3 Recommended mounting pattern on the host printed-circuit board for a CX4-type connector receptacle.

FIG. 4 Extending the reach of copper interconnects using optics.

FIG. 5 A communications adapter card, according to the one embodiment.

FIG. 6 An optical module according to one embodiment; view from (a) above and (b) from below.

FIG. 7 A detail of the communications adapter card with an optical module mounted on the adapter card printed-circuit board and protruding though a hole in the bracket, according to one embodiment.

FIG. 8 An embodiment of the optical module mounted on a printed-circuit board next to a CX4-type electrical connector receptacle, according to one embodiment.

FIG. 9 A view of an electro-optic sub-assembly according to the present invention (a) top view and (b) bottom view, according to one embodiment.

FIG. 10 An embodiment of the micro-optical chip according to the present invention (a) top view and (b) bottom view, according to one embodiment.

FIG. 11 A cross-sectional view through an transceiver module shown in FIG. 10, according to one embodiment.

FIG. 12 Block diagram of an embodiment of the optical module, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Present-day standards that regulate interconnect components and architectures (e.g. Gigabit Ethernet, 10-Gigabit Ethernet, Fibre Channel, InfiniBand, PCI-Express) specify line rates per channel between 1 GBaud and 10 GBaud, with 40 GBaud being explored in the near future. At these line rates copper solutions are limited to reaches of several meters.

The electrical cabling (also referred to as “copper interconnects”) has been dominating these short-distance applications because of cost and simplicity of implementing (electrical cables are typical passive and contain only electrical wires, albeit with precision electrical connectors attached). The drive to higher speeds and increasing distance of reach (due to ever expanding data center sizes) has resulted in gradual introduction of optical interconnect in recent years. A number of electronic equalization techniques have been employed in recent years to extend the reach of copper solutions, but this task is getting progressive more difficult, resulting in more expensive and more power consuming solutions.

For multi-gigabit interconnects in high-performance computing and data center applications (eg. InfiniBand Architecture, PCI Express), designers have the option of using a parallel cable interconnects with one, four, eight, and twelve channels in each direction (optical and electrical). The hardware and architecture implementations are described in the InfiniBand Specification available from the InfiniBand Trade Association Administration in Beaverton Oreg. or at www.infinibandta.org and the PCI-Express Specification available from PCI-SIG in Beaverton, Oreg. or at www.pcisig.com. The connection system with broadest field deployment is the electrical four-channel architecture. The electrical connector used for the four-channel interconnect is based on the 10 GB Ethernet Specification and commonly know as the 10-GBASE-CX4—in further text referred to as the “CX4” connector system.

Embodiments of the present disclosure include an interface card assembly platform and an optical module design that enables low-cost optical connectivity in data centers. The optical module is disclosed that is designed to fit within the keep-out areas specified for a relevant electrical connector used on conventional interface cards and electrically connects to the printed-circuit board as a the relevant electrical connector receptacle. The disclosed optical module is a drop-in replacement for the relevant electrical-connector receptacle, while it maintains all of the functions of an optical interface.

More specifically, the optical module is designed to fit within the keep-out areas specified for a CX4 electrical connector receptacle used on interface cards of various application-standards, such as, InfiniBand, Ethernet, and Fibre Channel, and electrically connects to the printed-circuit board in the place of the CX4 electrical connector receptacle. The optical module is a drop-in replacement for the CX4 electrical-connector receptacle, while it maintains all of the functions of an optical interface.

The advantage of one embodiment is in that one can manufacture only one printed-circuit board design that accepts electrical or optical physical media devices, or both. Furthermore, the installation of either type of interconnect solution can be done at a late stage in the card manufacturing process thereby minimizing the cost of the choice.

One embodiment furthermore offers the manufacturer the same amount of real-estate on the printed-circuit board for optics as for electronics.

One embodiment also allows the manufacturer to use room-temperature mounting technology for the optical transceiver

One embodiment allows the use of patch-panels and easy replacement of optical cables if the cables or the connectors should be damaged.

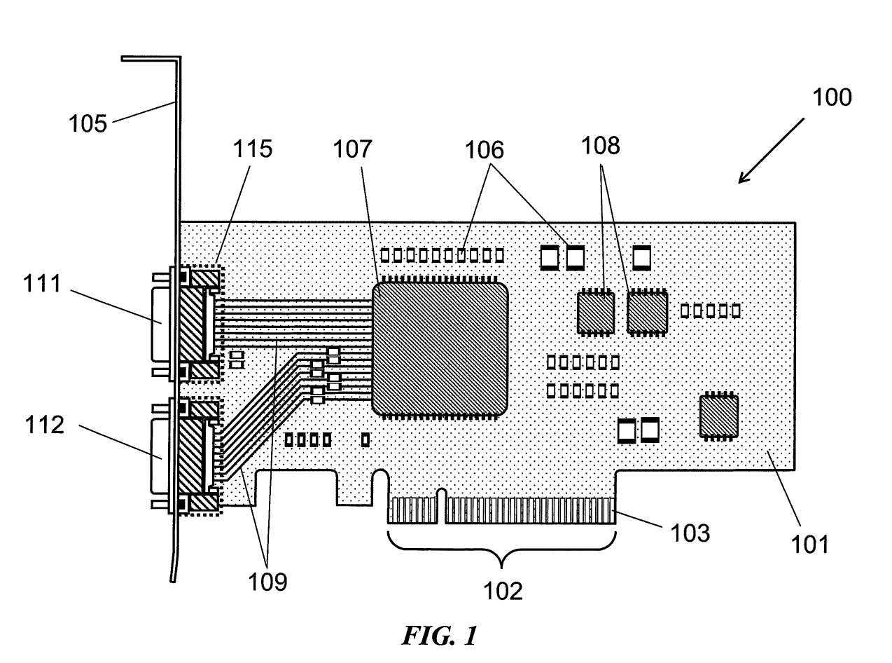

FIG. 1 illustrates a Dual-Port Infiniband™ Host-Channel Adapter (HCA) card 100.

The card 100 comprises a printed circuit board 101 with electrical traces 109 connecting various electronic components 106, 107 and 108 that are soldered to the printed circuit board 101. Electronic components 106 include passive components, such as, resistors, capacitors, and inductors. Active components 107 and 108 include integrated circuits, transistors, and diodes. In addition, an InfiniBand specific input/output processor 107 that processes the data and the network protocol is included on the adapter card. The adapter card 100 furthermore includes electrical card-edge connector 102 that plugs into a server motherboard (not shown) and is used for electrical communication to and from the motherboard. The card-edge connector 102 comprises a multiplicity of metalized pads 103 on one or both sides of the printer-circuit board 101 as is well-known in the computer and interconnect industry. The HCA card 100 furthermore comprises two CX4-type connector receptacles 111 and 112, also referred to as CX4 ports.

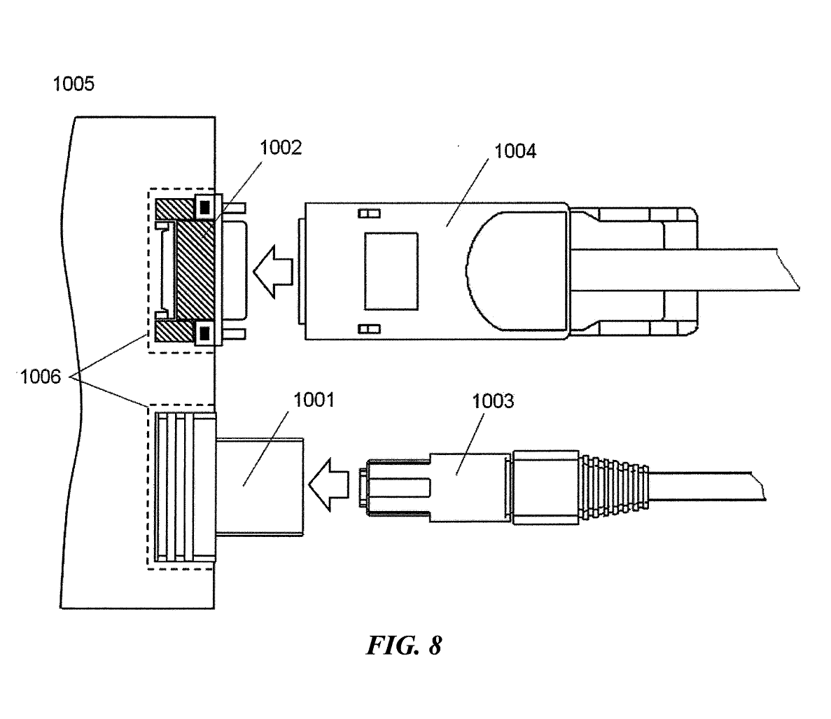

The receptacles 111 and 112 are soldered to the printed-circuit board 101 and completely fit within the CX4 keep-out areas indicated with the dashed lines 115. In normal operation, the HCA card transmits information in form of electrical signals between the card-edge connector 102 and the electrical CX4 ports 111 and 112. The CX4 ports 111 and 112 are connected to another HCA or switch card (not shown) located remotely at a distance away from the shown HCA 100. When the connection to the other cards is realized using electrical cabling, the electrical cable features a CX4 connector plug on each end (for example 1004 in FIG. 8). Cost-wise, the manufacturers favor the HCA card implementation shown in FIG. 1, because the cost of both the CX4 connector receptacle installed on the printed-circuit board and the CX4 plug-equipped electrical cable is relatively low and there are multiple manufacturers of these components. Although the host-channel adapter board 100 is shown with two CX4 connector receptacles (111 and 112) attached, the host-channel card may also have only one CX4 port. A different card may have multiple CX4 ports.

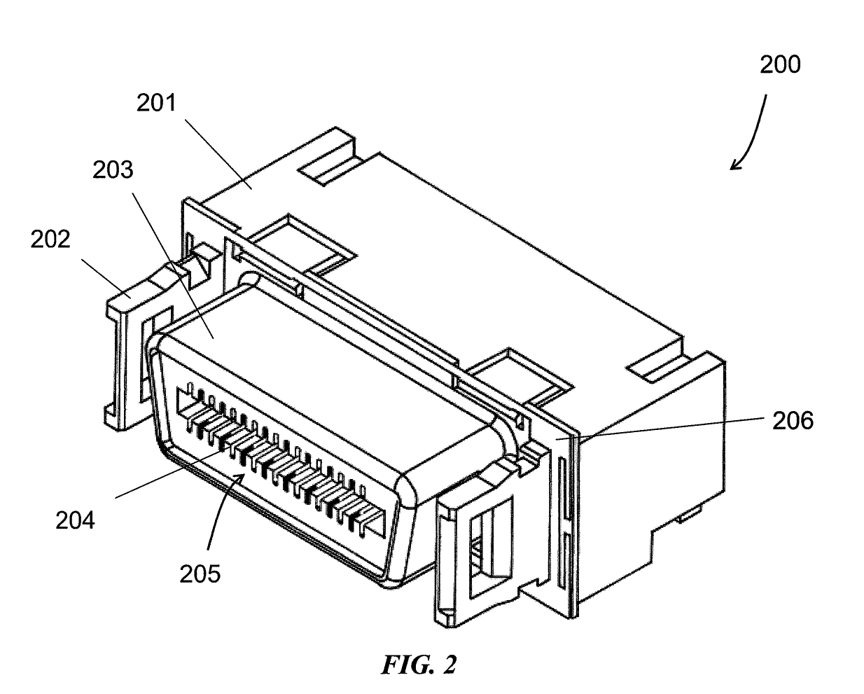

One implementation of the CX4 connector receptacle is shown in FIG. 2.

The receptacle 200 comprises of a receptacle body 201, a pair of latching bars 202 extending from the body 201, front-end electromagnetic shield 203, two rows of electrical connection pins 204, eighteen on top and eighteen on the bottom of the front-end connector opening 206, an electromagnetic compression gasket 206 for contacting a faceplate (bracket 105 in FIG. 1). The receptacle 200 is soldered to a printed circuit board with metalized contacts appearing below the receptacle (not visible in FIG. 2).

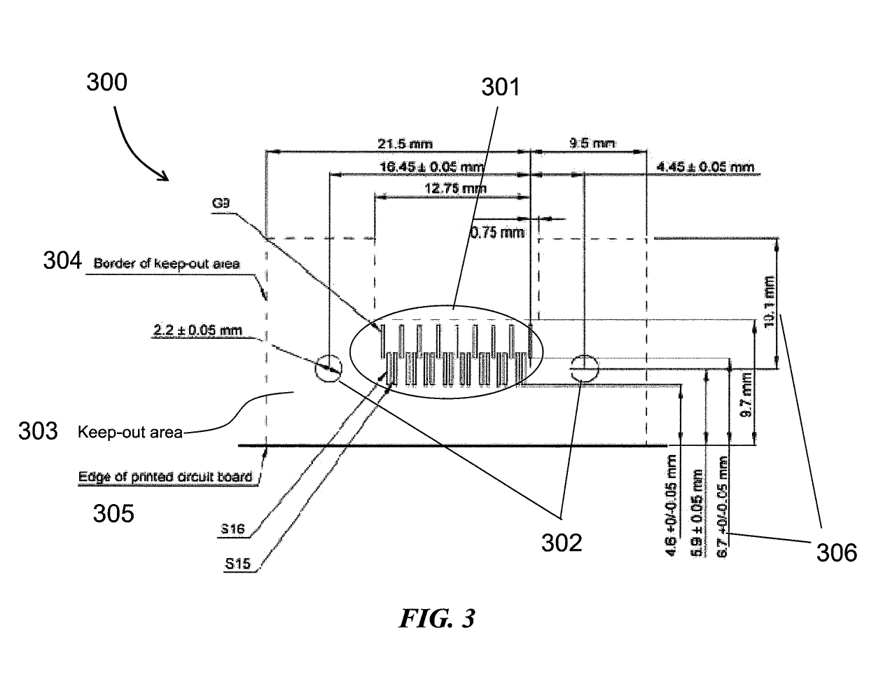

FIG. 3 shows the recommended mounting pattern 300 on the host printed-circuit board 101 that is used to mount and electrically connect the CX4 receptacle 200 to the printed circuit board 101.

The recommended mounting pattern 300 comprises recommended metalized-trace pattern 301 on the printed-circuit board 101 which will be used to contact the CX4 connector 200 by soldering, location of at least two mounting thru holes 302 which are used to align the CX4 connector receptacle, the keep-out area 303 delineated with the keep-out area border 304, and the location of the edge 305 of the printed circuit board relative to the metalized trace pattern 301. All relevant dimensions 306 are specified by the InfiniBand standard. The number of connector pads for a CX4 connector is 25: there are eight differential high-speed contacts (sixteen in total) and nine pads that area referred to as ground. These are connected to the front-end pins 204 shown in FIG. 2.

The keep-out area is provided to ensure that a CX4-compliant connector receptacle from any manufacturer will fit on any one board which is intended to accept it. No other components mounted on the printed-circuit board, such as, resistors, capacitors or integrated circuits mounted on the printed circuit board may intrude into the keep-out area 303 without endangering the manufacturability of the board. The CX4 connector is allowed to extrude outside of the printed-circuit board past the printed-circuit board edge 305. The extrusion outward and sideways outside of the printed-circuit board depends on the application and the applicable adaptor board standard.

The CX4 electrical interconnect system is commercially used for short-distance electrical interconnects up to 5 GBaud per channel, 20 GBaud total bandwidth in each direction over distances up ten meters. However, in many applications longer reaches are needed and as bandwidth increases to 10 Gbaud per channel, copper interconnect will have to give way to optics. Industry has been exploring several different options to address this yet unmet need.

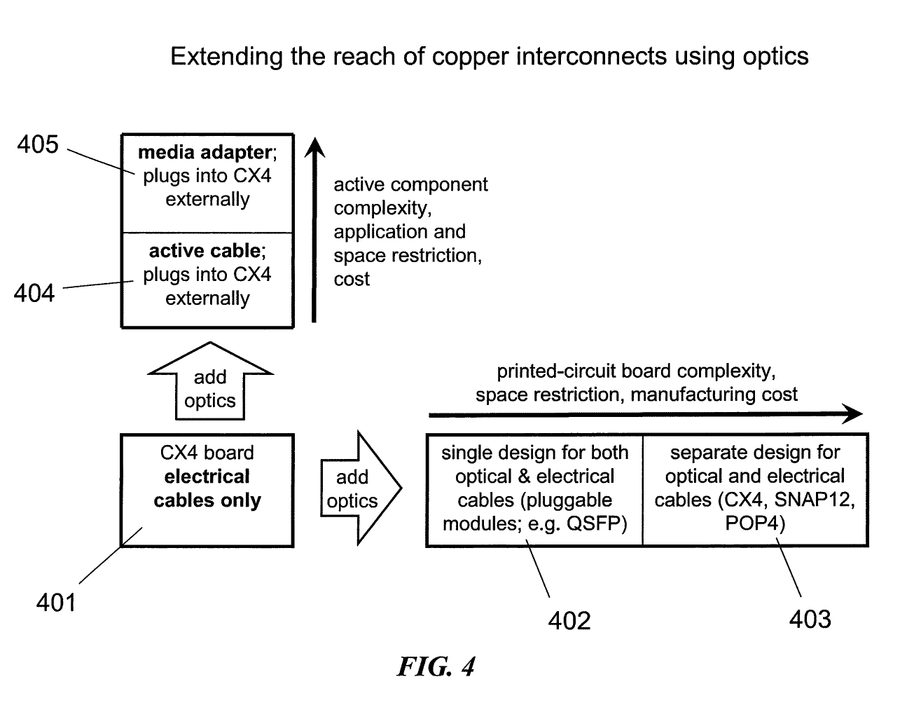

The development of different approaches to extend the reach by implementing optical solutions will be explained next with the help of FIG. 4 and the block diagram 400.

The central, starting solution is a CX4 board that uses electrical cables only illustrated with the block 401. This approach is illustrated in FIG. 1. The blocks shown in diagram 400 illustrate two directions of technological development by adding optics. To the right of the block 401, the technology involves increasing the complexity and cost of the printed-circuit board, namely, the adapter card, while upward from the block 401 represents increase in the complexity and price of the optical module, while maintaining the CX4 board intact.

The first approach investigated in the industry has been to increase the complexity of the printed-circuit board by installing any one of the traditional fiber-optic modules onto the PCB and then use optical fiber to connect to the other ports. Traditional fiber-optic modules are available from manufacturers like Agilent Technologies, JDSU, and Finisar in California. This approach is represented with the block 402. Unfortunately, all these fiber-optic modules are larger than the CX4 connector, require their set of control signals, and own signal trace patterns on the PCB. This presents a difficulty for the adapter manufacturer as he or she has to develop two separate designs for two adapters: one electrical and one optical. This means more parts sourced and manufactured, increasing the cost and logistics.

The resolving of the difficulties with approach 402 was attempted by the introduction of pluggable module technology (block 403), in which a cage that could accept an optical or electrical module with the same form factor was mounted on the printed-circuit board. Once inserted, the module made electrical connection to the adapter printed-circuit board via an edge-connector in the back of the cage. Multiple manufacturers of modules offer such products. Examples of this approach are the SFP, XFP, and QSFP form-factors, description of which can be found in their respective multi-source agreements.

The modules that were able to plug into such cages can be passive electrical, active electrical equalization modules, or optical modules. In this way the electrical and optical module mechanical shape is adjusted to fit into the cage and both module types have the same connection scheme, and same pinout. The disadvantage of this solution for very high-density interconnects has been the size: The cage, electromagnetic interference requirements, pluggable-module latching mechanism, and cage-back-end connector made the pluggable optical transceivers quite large in comparison with the CX4 electrical receptacle. In some cases, the size difference became a prohibitive obstacle for host channel adapters. For example, two pluggable solutions with 20 Gb/s bandwidth each (e.g. QSFP) would not fit next to the electronic on the board shown in FIG. 1.

The exploration of different solution also extended into a different direction where the host-channel card was kept unchanged, with a CX4 connector on it, but the complexity was shifted to the optical modules. This is illustrated by moving upward in FIG. 4 towards block 404. The philosophy behind these products was to leave the HCA card intact with electrical CX4 receptacles attached and offer a separate product that would plug into the CX4 receptacle from the outside of the adapter card and convert the electrical signal into optics. The other side of the converter product would have an optical port with a standard fiber connector receptacle, in which case this product was referred as the media adapter 405 and manufactured by Emcore Corporation in New Jersey or Zarlink in Sweden. If fiber-optic cable was permanently connected the product was referred as the active optical cable 404.

Although this was an improvement over the pluggable solutions, these products also suffer from several disadvantages: the media converter 405 is large and hangs far from the adapter card making it difficult to close the network cabinet and makes it very sensitive to damage from fiber pull, while the need for two separate ports (optical and electrical in the same component), sturdy package, and electromagnetic protection make the media-adapter 405 too expensive for broad market adoption. The active optical cable 404 suffers from the problem that custom lengths have to be specified, one cannot pass the fiber-ribbon though patch panels as is often needed in a data center, and once one port is damaged, the entire cable (fiber ribbon and the other optical/electrical converter attached to the other side) has to be discarded making the cost of ownership higher.

The above-presented developments of interconnect solutions are indicative of the difficulty the interconnect industry has been facing in finding the right solution to cost-effectively interconnect high-performance computing centers. Satisfying the reach requirements in the presence of an ever-increasing data rate is yet to be adequately resolved. It is clear therefore that a need exists in the industry for an inexpensive optical solution that offers reach at high data rates, while maintaining the flexibility and the cost model of the existing copper interconnect technology. A solution of this type is essential for sustaining the interconnect technology to the next generation. This application presents such a solution.

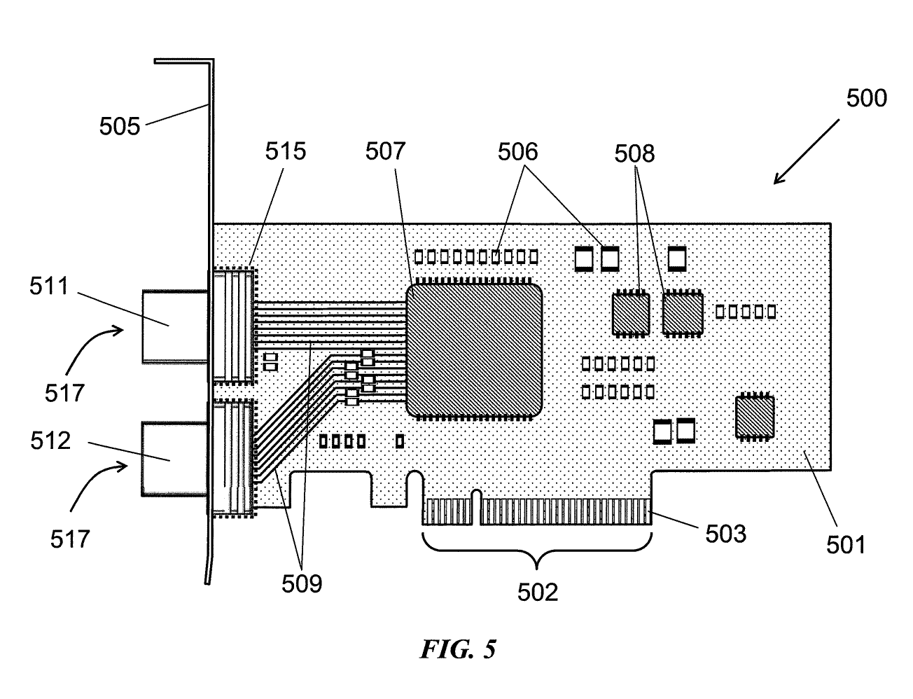

One embodiment allows simple replacement of the optical module for purpose of upgrading or replacement due to damage. A view of an interface adapter card 500 according to the present embodiment is shown in FIG. 5.

In one embodiment, the interface adapter card 500 is a host-channel adapter card. In another embodiment, the interface adapter is a switch card, and yet in another embodiment the interface card is an Ethernet communications card. The interface adapter card may utilize any communications protocol without departing from the present invention.

The interface adapter card 500 comprises a printer circuit board 501 with electrical traces 509 connecting various electronic components 506, 507 and 508 that have soldered to the printed circuit board 501. The electronic components include passive components, such as, resistors, capacitors, and inductors, illustrated with components 506, a variety of active components, such as, integrated circuits, transistors, diodes, illustrated with 507 and 508. Generally, the components include an application-specific input/output processor 507 that processes the data and the communication protocol.

The card 500 features electrical card-edge connector 502 that plugs into a server motherboard (not shown) and is used for electrical communication to and from the motherboard. The card-edge connector 502 comprises a multiplicity of metalized pads 503 on one or both sides of the printer-circuit board 501 as is well-known in the computer and interconnect industry. The multiplicity of metalized pads 503 makes contact with the metal contacts on the mother board (not shown). In one embodiment, the application-specific input/output processor is an InfiniBand™ processor. In another embodiment, the application-specific input/output processor is an Ethernet processor. In yet another embodiment, the application-specific input/output processor is a Fibre-Channel processor.

The interface card 500 comprises at least one optical module according to one embodiment. One embodiment of the interface card 500 furthermore comprises two optical modules 511 and 512 configured to fit within the borders of CX4 keep-out areas 515. In another embodiment, the interface adapter card 500 comprises at least one optical module. In yet another embodiment, at least one electrical connector receptacle is used in conjunction with at least one optical module.

Specifically, the part of the optical module (511 or 512) that is attached and resides above the printed-circuit board 501 is confined within the borders 515 of the keep-out area specified for the CX4 connector receptacle. The optical modules 511 and 512 are attached to printed-circuit board 501 by soldering, room-temperature elastomeric contact, or any other technique known in the art. In normal operation, the interface adapter card transmits information in form of electrical signals between the card-edge connector 502 and the optical modules 511 and 512 located in place of the CX4 ports in the same manner is it would when the printed-circuit board 501 is populated with CX4 ports (as shown in FIG. 1, for example). The optical modules 511 and 512 are connected to another interface adapter located remotely at a distance away from the shown interface adapter card 500. The connection to the other cards is realized using fiber-optic ribbon cable (not shown).

The fiber-optic ribbon cable may be terminated using one of many ribbon-cable connectors. In one embodiment, the cable is terminated with an MPO-type connector and that in that case the optical ports 517 on the optical modules 511 and 512 comprise MPO-type optical receptacle. The MPO optical receptacle is described in IEC standard IEC 61874. In another embodiment, the optical port 517 is configured to accept Methode MPX optical ribbon connector, and yet in another embodiment the optical port 517 is configured to accept Infineon SMC connector. It clear that the invention described above can be used on any type of computer adapter cards: a switch card, an Ethernet communications card, or a line card for telecommunications equipment are just some examples. Furthermore, it is clear that number of optical ports per card can vary without departing from the spirit of the invention.

In general, the interface adapter card 500 is very similar to the host-channel adapter card 100. The main difference is that the interface adapter card 500 contains at least one fiber-optic module in accordance with the present invention, while the host-channel adapter card 100 contains only CX4 electrical connector receptacles.

According to InfiniBand and Fibre-Channel Physical Interface (FC-PI) specifications, interface adapter cards allow for plugging in either a passive electrical cable or active cables (optical or electrical). Active cables that plug into the CX4 connector receptacle may be equalized electrical cables (sometimes referred to as active electrical cables), media adapters or active optical cables described above. When an active cable is plugged into the interface adapter externally into the CX4 connector, the interface adapter card must turn on power to the active cable, has to be able to receive and provide several control and monitoring signals (laser enable flag and laser fault, if optical element is plugged in). For this reason the interface adapter board has to detect type of externally connected module (passive or active) on provide power and external function when necessary.

The electronic circuits present on the host-channel adapter board that perform these functions are collectively referred to as “media detection” circuitry. Consequently, any active cable plugged into the CX4 electrical connector receptacle includes circuitry that differentiates it from a passive electrical cable connector and provides the control or monitoring signals to the host-channel adapter. This circuitry, present on the active cables is referred to as “media identification” circuitry. Media identification circuitry does not appear on traditional fiber-optic modules which are attached to printed-circuit boards (described in 402).

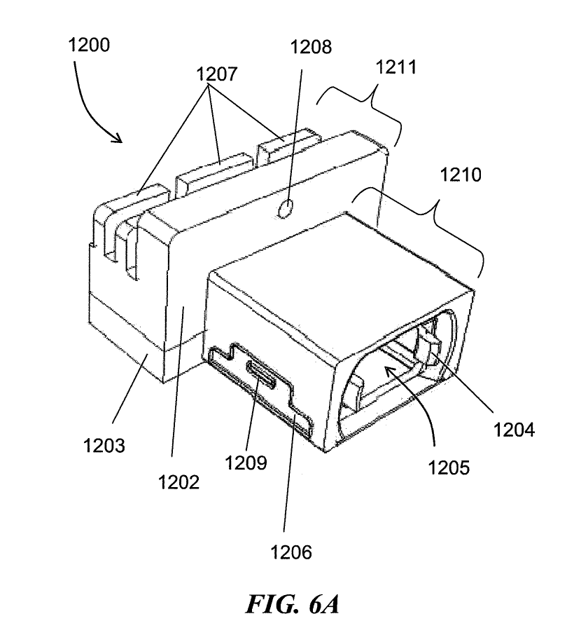

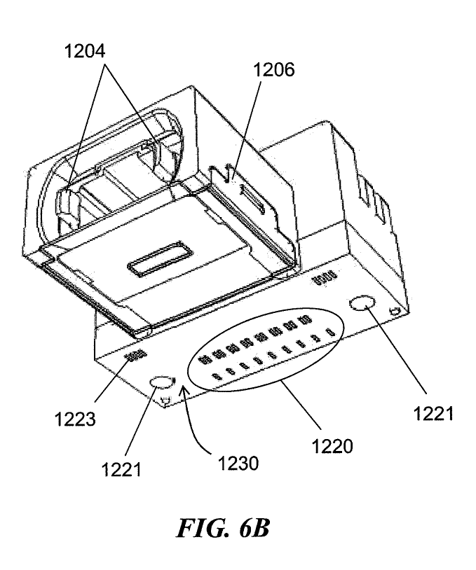

One embodiment of the optical module is shown in FIG. 6.

A fiber-optic module 1201 designed in accordance with the present invention comprises a housing 1202, module printed-circuit board 1203, optical receptacle 1204, and cover clip 1206. The housing 1202 has two parts: the module body 1211 and the optical-receptacle housing 1210. The optical-receptacle housing 1210 houses the optical port 1205 within which the optical receptacle 1204 is located. The optical receptacle 1204 is enclosed from the bottom of the optical port 1205 with the cover clip 1206. The housing 1202 comprises heat-dissipating fins 1207 and threaded mounting hole 1208 located on the module body 1211.

The exposed side 1230 of the printed-circuit board 1203 comprises metalized traces 1220 for high-speed electrical connection, metalized traces 1223 for low-speed and control connection, and mounting holes 1221. The metalized-trace 1220 pattern is compliant with CX4 solder pads 301 defined by the InfiniBand standard and illustrated in FIG. 3. The mounting holes 1221 are through holes through the printed-circuit board 1203 and are threaded into the optical module body 1211. In one embodiment, the clip 1206 is made out of sheet metal and holds the optical receptacle 1204 in place within the optical port 1205. The clip 1206 attaches to the optical-receptacle housing 1210 using a hook 1209.

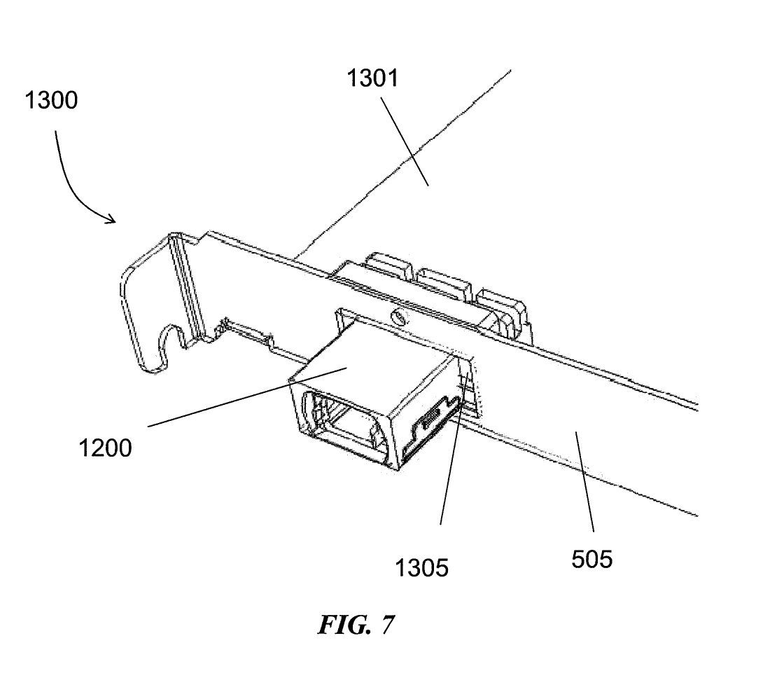

When installed on the interface adapter card 500, the module body 1211 resides on top of the adapter printed circuit board 501 and is substantially confined within the keep-out areas 515. When the optical module 511 (or 512) is installed on the interface adapter card 500, the optical-receptacle housing 1210 protrudes through the opening in the bracket 505 as illustrated in FIG. 7.

FIG. 7 shows a detail of the adapter card 1300 with one embodiment of the optical module 1304 mounted on the adapter card printed-circuit board 1301 and protruding though a hole 1305 the in the bracket 1302.

FIG. 8 illustrates one embodiment of the optical module design 1001 mounted on an InfiniBand adapter printed-circuit board 1005 next to a CX4 connector receptacle 1002.

In one embodiment, the optical module 1001 connects to a standard MPO-type optical connector plug illustrated with 1003, while the CX4 connector 1002 connects to a standard CX4 connector plug 1004. In one embodiment, one printed circuit board 1005 has two ports: one electrical port 1002 and one optical port 1001. Regardless of the type of port, electrical or optical, the keep-out areas 1006 on the printed-circuit board 1005 are identical and enable the manufacturer to use a single printed-circuit board design for either electrical or optical port installations.

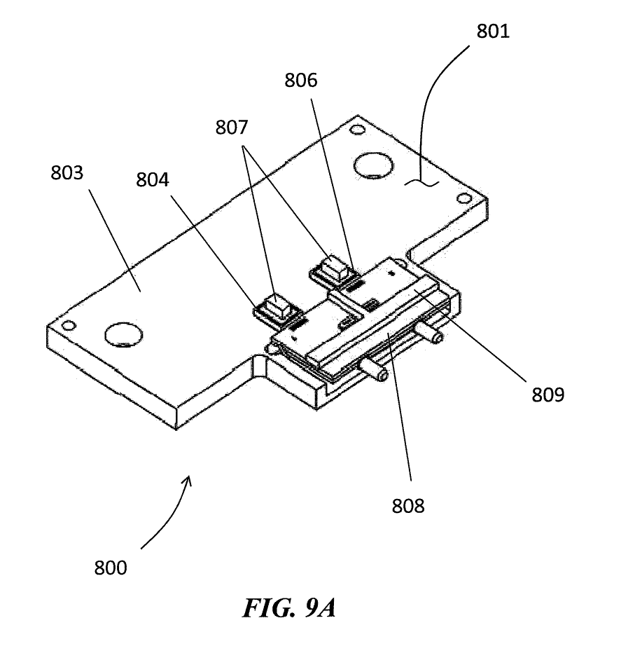

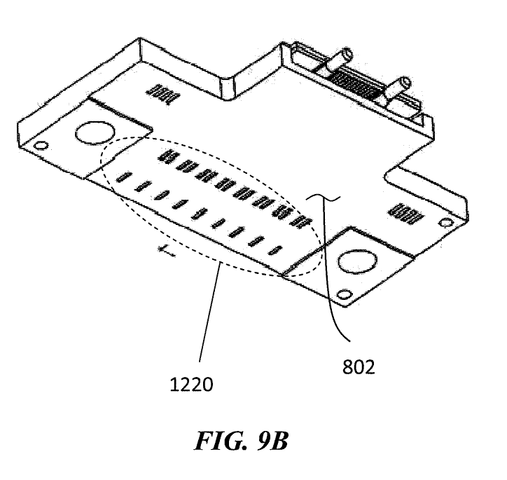

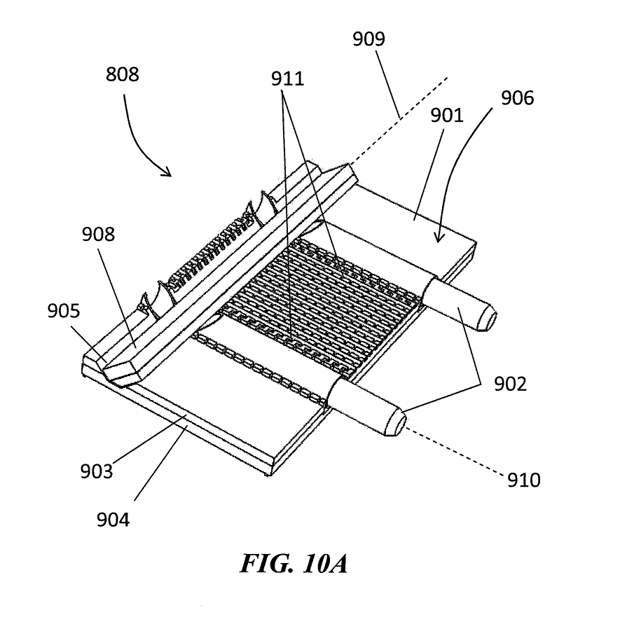

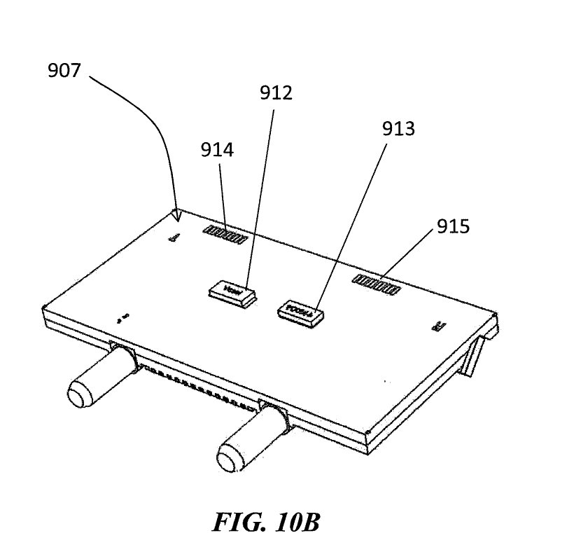

The inside of the optical module 1200 is further explained with the help of FIGS. 9 and 10. The active element of the optical module 1200 disposed on the module printed-circuit board 1203 are seen when the module housing 1202 is detached from the module printed-circuit board 1203. The optical receptacle 1204 and the module clip 1206 remain attached to the module housing 1202 when the housing 1202 is removed from the module printed circuit board 1203.

One embodiment of the printed-circuit board 1203 with attached active elements is illustrated and explained with the help of FIG. 9.

In FIG. 9, the electro-optic sub-assembly 800 is illustrated. The module printed-circuit board assembly 800 comprises a multi-layered printed-circuit board 803, a laser-driver integrated circuit 804, receiver integrated circuit 806, two heat-conducting blocks 807, one disposed on the laser-driver integrated-circuit chip 804 and the other on the receiver integrated-circuit chip 806, one micro-optical chip 808 with components attached to it all of which will be described in detail with help of FIG. 10 in later text, and a electromagnetic shield 809 attached to the top surface of the micro-optical chip 808. The top surface of the module printed circuit board 803 is denoted with 801, while the bottom surface is denoted with 802. As described in the description of FIG. 6, the bottom 802 of the module printed-circuit board 803 comprises metalized traces 1220 configured to align to the metalized contacts for the CX4 connector receptacle on the host-adapter card printed-circuit board according to FIG. 3.

In the fully assembled optical module 1200, the heat-conductive blocks 807 provide heat conduction from the integrated circuits 805 and 806 to the module housing 1202. The heat is further dissipated via the heat-sinking fins 1207 or via conduction to the bracket 505 when module 1200 is attached to the bracket 505. This arrangement provides heat sinking to the integrated circuits that reduces the temperature of the operation of the lasers, photo-detectors, and integrated circuits and enhances the reliability of the optical module 1200.

In one embodiment, the optical port 1205 contains an optical receptacle configured according to the MPO standard. In other embodiments, the optical receptacle is configured to accept a fiber-ribbon connectors defined by one of a number of other industry standards, such as, SMC (Infineon), MD (Hirose), MPX (Methode) may be used without departing from the spirit of the invention.

An embodiment of the micro-optical chip 808 is shown in more detail in FIG. 10.

The micro-optical chip 808 comprises a substrate 901, two pins 902 embedded in the top surface 906 of the substrate 901, a layered mirror bar assembly 908 disposed inside a notch 905 in the substrate 901 with the angle of the layers and the surfaces of the layered mirror bar assembly 908 having an angle of substantially 45 degrees relative to the surface 906 of the substrate 901, an array of fibers 911 disposed parallel to the surface 906 of the substrate 901, parallel to the pins 902 and perpendicular to the direction of the mirror bar assembly 908. In one embodiment the substrate 901 comprises two layers 902 and 903, layer 902 being proximal to the top surface 906 of substrate 901.

At least layer 904, layer 904 being proximal to the bottom surface 907 of substrate 901, is transparent and it allows the light to penetrate from the fibers 911 on the top surface 906 of the substrate 901 to the bottom side 907 of the substrate 901. On the bottom side 907 of the substrate 901 at least one vertical-cavity surface-emitting laser array chip 912 is disposed in such a way that light couples from the laser array chip 912 to the optical fibers 911 via reflection inside the mirror bar assembly 908. A photodiode array chip 913 is disposed on the bottom surface 907 so that light incident from the outside though the fibers 911 couples into the photodiodes in the array 913 via a reflection in the mirror bar assembly 908.

The micro-optical chip 900 exhibits what is commonly referred to as an “optical turn”: the direction of light from the laser turns at a right angle (ninety degrees) prior to being coupled into the fiber or the fiber-optic connector. The assembly of the micro-optical chip enables the fiber-optic module to realize a short and low profile architecture enabling direct replacement of the CX4 electrical connector with an optical assembly.

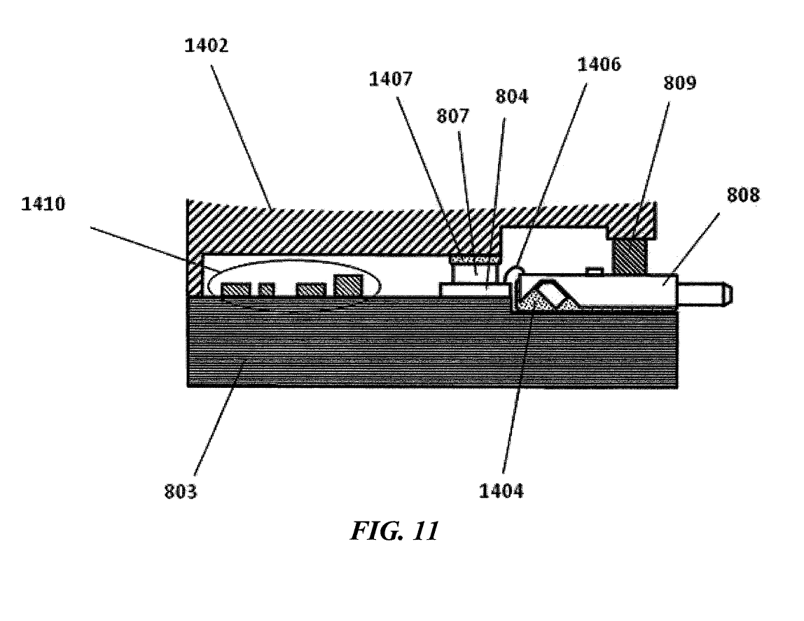

FIG. 11 is a cross-section through a transceiver module as shown in the example of FIG. 9.

The cross-section is taken lengthwise (parallel to the optical fibers) and illustrates how the micro-optical chip 808 and the active components 804 disposed on the module printed-circuit board 803 are thermally and electromagnetically coupled to the housing 1202. In FIG. 11, a section 1402 of the housing 1202 is shown where the heat dissipated by the integrated circuit 804 is conducted to the housing 1402 via a block of aluminum nitride 807 and thermally conductive paste 1407. The electrical contacts to the integrated circuit are realized as bond-wires 1406 and the electromagnetic shielding of the micro-optic chip 808 is realized using the RF damping gasket 809 which is connected between the micro-optical chip 808 and the housing 1202 providing grounding and shielding.

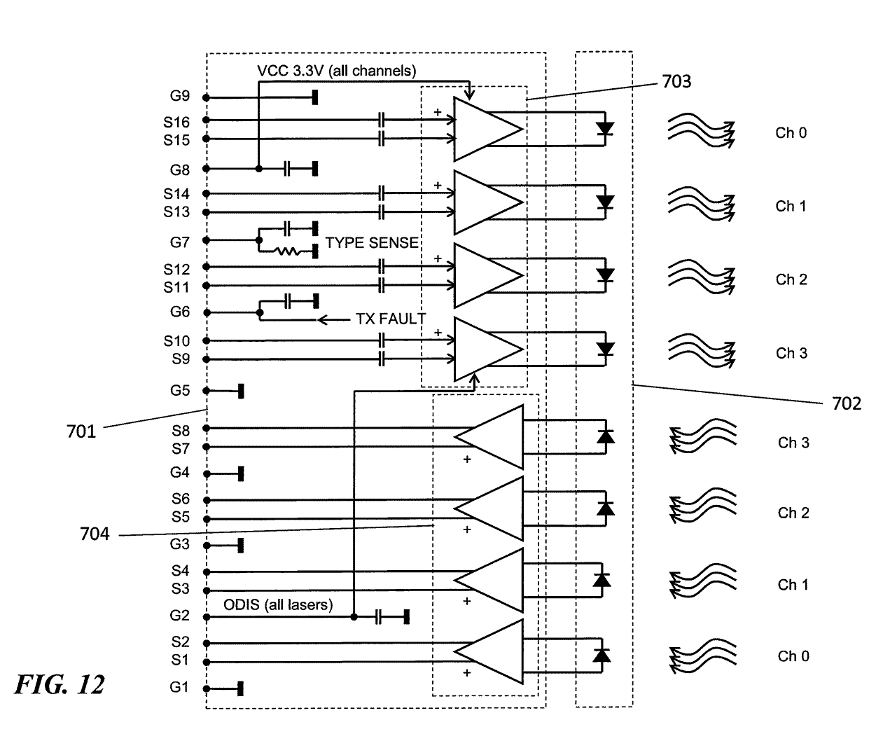

FIG. 12 illustrates the electrical block diagram of the optical transceiver module 1200.

The electrical signals are provided to the module 1200 via metalized traces 1220 on the bottom 802 of the electro-optical sub-assembly 800 and are numbered according to the specification given in InfiniBand specification. The pins starting with letter ‘S’ refer to high-speed differential signaling lines: Four differential inputs into the optical module (S9 through S16) and four differential outputs from the optical module (S1 through S8). The high-speed electrical input signals (S9-S16) are fed into the laser-driver array chip 912 delineated with the dashed box 703, while four differential lines (S1-S8) bring the output from the receiver integrated array chip 913 delineated with dashed box 704 to the outside connectors S1-S8. The lines and chips located within the dashed box 701 are realized on and within the multi-layered printed-circuit board 803, while the lasers and the photodetectors are attached to the micro-optical chip as delineated with the dashed box 702.

On one embodiment, the electrical contacting to the printed circuit board 501 is realized using metallic electrical wires embedded within silicone material, such as, the Pariposer® material manufactured by Paricon Technologies of Fall River, Mass., USA. In this embodiment, the silicon rubber material with embedded silver balls is placed between the host printed-circuit board 501 and the bottom surface 1230 of the optical module 1200 aligned so that when the module is tightened to the printed-circuit board 501, contacts are made through the elastomeric contact material and between the electrical pads 1220 on the optical module 1200 and the metalized traces on the printed-circuit board 501. In one embodiment the metalized traces correspond to CX4 electrical connector receptacle and are shown in FIG. 3.

In another embodiment, the electrical contacts between the optical module 1200 and the printed-circuit board 501 is realized using plastic-core solder balls. An example of such product is the Micropearl technology manufactured by Sekisui Chemical Co., Ltd from Japan.

This design of the optical module allows for a spatial separation between the main heat sources (laser driver array chip 804 and the receiver array chip 806) from the laser array chip 912 and the photo-detector array chip 913 thereby lowering the temperature of the lasers and the photo detectors. The abovementioned spatial separation furthermore allows to use a different substrate upon which the electrical and optical components are located: The optical components are disposed on the micro-optical chip 808 allowing coupling to the optical fibers, while the electrical chips (drivers and receivers) are mounted on the printed circuit board 803 which enables efficient and inexpensive manufacturing and testing of its electrical properties, lending itself to high-volume manufacturing.

Furthermore, one embodiment of the optical module is different from all optical modules designed and manufactured prior to this invention is that the optical module includes media identification circuitry.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶16, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

1. A communications adapter card comprising:
a printed-circuit board, the printed circuit board having at least one keep-out area, the at least one keep-out area configured to accept a multi-contact electrical connector receptacle;
at least one optical module attached to the printed circuit board;
wherein the at least one optical module is attached to the printed circuit board substantially within the at-least-one keep-out area.

2. Communications adapter card of claim 1, further having
a multiplicity of metalized connection pads, the multiplicity of metalized connection pads located within the at least one keep-out area and configured to electrically connect to the multi-contact electrical connector receptacle,
wherein the multiplicity of metalized connection pads are electrically coupled to the optical module.

3. Communications adapter card of claim 2, wherein the communications adapter card is an InfiniBand Host Channel Adapter.

4. Communications adapter card of claim 1 wherein the optical module includes a media identification circuit.

5. Communications adapter card of claim 1, wherein the multi-contact electrical connector receptacle is a CX4-type connector receptacle.

6. Communications adapter card of claim 1, wherein the optical module comprises an optical chip, said optical chip comprising an optical turn.

7. A communications module comprising of a printed-circuit board, said printed circuit board having N keep-out areas, N being a natural number, each keep-out area of the N keep-out areas configured to accept a multi-contact electrical connector receptacle;
M optical modules attached to the printed-circuit board, M being a natural number smaller or equal to N;
wherein each optical module of the M optical modules is attached to the printed-circuit board substantially within each keep-out area of the M keep-out areas.

8. The communications module of claim 7, further having
a multiplicity of metalized connection pads, the multiplicity of metalized connection pads located within each keep-out area of the N keep-out areas and configured to electrically connect to the multi-contact electrical connector receptacle,
wherein the multiplicity of metalized connection pads in each of the M keep-out areas of the N keep-out areas are electrically coupled to each optical module of the M optical modules.

9. The communications module of claim 7, wherein the multi-contact electrical connector is a CX4-type connector receptacle.

10. The communications module of claim 8, wherein the optical module is an optical transceiver.

11. The communications module of claim 8, wherein the optical module is a multi-channel optical transmitter.

12. The communications module of claim 8, wherein the electrical connection between the optical module and the printed-circuit board is realized using an intermediate layer comprising electrical contacts disposed between the optical module and the printed-circuit board.

13. The communications module of claim 7, further comprising
a media detection circuit;
a media identification circuit comprised in the optical module.

14. The communications module of claim 13, wherein the electrical connection between the optical module and the printed-circuit board is realized using an intermediate layer comprising electrical contacts disposed between the optical module and the printed-circuit board.

15. The communications module of claim 13, wherein the optical module is configured to be mechanically attached to the printed circuit board at room temperature.

16. An optical module comprising of
an optical chip, said optical chip comprising a vertical-cavity lasers and optical fibers configured in an optical turn configuration
a printed-circuit board, said printed-circuit board having a metalized trace pattern configured to attach to a multi-contact electrical connector receptacle.

17. The optical module of claim 16, wherein the multi-contact electrical connector receptacle is a CX4-type connector receptacle.

18. The optical module of claim 16, further comprising
a housing;
at least one integrated circuit;
at least one thermally conductive block disposed between and in thermal contact with the housing and the at least one integrated circuit.

19. The optical module of claim 18, wherein the thermal contact is further established using a thermally conductive paste disposed between the thermally conductive block and the housing.

20. The optical module of claim 18, wherein the thermally conductive block is made out of aluminum nitride.
